(19) United States
(12) Patent Application Publication
(10) Pub. No.: US 2007/0256106 A1
(43) Pub. Date: Nov. 1, 2007

(54) Controller for filtering sub-channels of digital video broadcast

(76) Inventors: Wen-Ming Huang, Dasi Township (TW); Chi-Wei Hsiao, Jhonghe City (TW); Wen-Fu Tsai, Renwu Township (TW); Ching-Chun Huang, Taipei City (TW); Hsin-Ching Yin, Gangshan Township (TW); Chi-Hsien Wang, Yonghe City (TW); Ching-Lai Tsai, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,199

(22) Filed: May 11, 2007

(30) Foreign Application Priority Data
May 1, 2006 (TW) 095207385

(51) Int. Cl. H04N 7/18

(52) U.S. Cl. 725/80; 725/74; 725/78

(57) ABSTRACT

A controller for filtering sub-channels of DVB is provided, including a media access control (MAC) unit, at least a data compression unit and at least a physical interface circuit. The MAC unit includes a plurality of registers. The MAC unit is connected to the DVB packets through a bus, and the registers provide storage for the program identification of at least one DVB sub-channel packet so that the MAC unit can determine whether to discard or output the DVB packet based on the program identification. The data compression unit is connected to MAC unit for being controlled to determine whether the packet should be compressed before output. The physical interface circuit is connected to the MAC unit and the data compression unit for outputting the compressed or uncompressed packets.

### BACKGROUND OF THE INVENTION

1. Field of the Invention

The present invention relates to a controller for filtering sub-channels of digital video broadcast (DVB) and, more particularly, to a controller for determining whether a buffered DVB data packet should be discarded, compressed and output, or output directly based on the video frequency program identification of the sub-channels of DVB.

2. The Related Arts

As the technology progresses, the users demand higher quality of video broadcast. Digital video broadcast (DVB) and high definition television (HDTV) are gaining attentions because these technologies can broadcast programs requiring higher digital audio and video quality, such as Olympics Games, World Cup, and so on.

On the other hand, the universal serial bus (USB) port in the PC provides connections to a variety of USB products, such as USB keyboard, USB mouse, USB card reader, USB flash memory pen, USB hard disk, USB printer, and USB scanner. The earlier USB1.0 supports 12 Mbps data transmission, and the current USB2.0 supports 480M bps data transmission.

According to the USB specification, USB1.1 supports both low speed peripherals at the data transmission speed of 1.5 Mbps with tolerance rate 1.5% and full speed peripherals at the data transmission speed of 12 Mbps with tolerance rate 0.25%. USB2.0 supports high speed peripherals at the data transmission speed of 480 Mbps. The low speed peripherals include USB keyboard, USB mouse, USB joystick, and full speed peripherals include USB flash memory pen, USB printer and USB scanner. USB2.0 is downward compatible with USB1.1; that is, USB2.0 also supports low speed and full speed peripherals.

FIG. 1 of the attached drawings shows a block diagram of a conventional USB DVB receiving device, comprising an antenna 200, an RF tuner 210, a demodulator 220, and a USB controller 230. When the DVB signal, including video signals, audio program identification, and control packets, transmitted through air enters antenna 200, the DVB receiving device must receive the RF signal from RF tuner 210, decode the RF signal with decoder 220, and transmit MPEG2 video signal to USB controller 2.0 to communicate with the host through the USB2.0 high speed transmission interface.

FIG. 2 of the attached drawings shows a transmission packet 240 of DVB. Each packet is 188 bytes long, including a program ID (PID) to indicate the type of the packet.

According to the receiving process of a conventional USB DVB receiving device described in FIGS. 1 and 2, the problem limited bandwidth arises. For example, the bandwidth of USB1.1 controller cannot be used in broadcasting HDTV programs because the amount of packets 240 used in DVB demands higher transmission bandwidth.

Taiwan Patent Publication No. 200608768 disclosed a method and related controller for filtering the sub-channel of DVB. The disclosed method and related controller includes techniques to use the video frequency program identification to filter the packets.

### SUMMARY OF THE INVENTION

An object of the present invention is to provide a controller for filtering sub-channels of DVB, including the use of a media access control (MAC) unit to filter the packets to determine whether to discard, compress and output, or directly output based on the program identification to reduce the unnecessary traffic.

Another object of the present invention is to provide a controller for filtering sub-channels of DVB, including the use of a data compression unit connected to an MAC unit to be controlled by the MAC unit to compress certain packets of DVB sub-channels. This is to reduce the bandwidth so that USB1.1 specification receiver can also play HDTV programs.

To achieve the above objects, the present invention provides a controller for filtering sub-channels of DVB, comprising a media access control (MAC) unit, at least a data compression unit and at least a physical interface circuit. The MAC unit includes a plurality of registers. The MAC unit is connected to the DVB packets through a bus, and the registers provide storage for the program identification of at least one DVB sub-channel packet so that the MAC unit can determine whether to discard or output the DVB packet based on the program identification. The data compression unit is connected to MAC unit for being controlled to determine whether the packet should be compressed before output. The physical interface circuit is connected to the MAC unit and the data compression unit for outputting the compressed or uncompressed packets. Thus, the controller of the present invention has a higher transmission bandwidth and higher HDTV quality.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of a conventional USB receiving device for DVB;

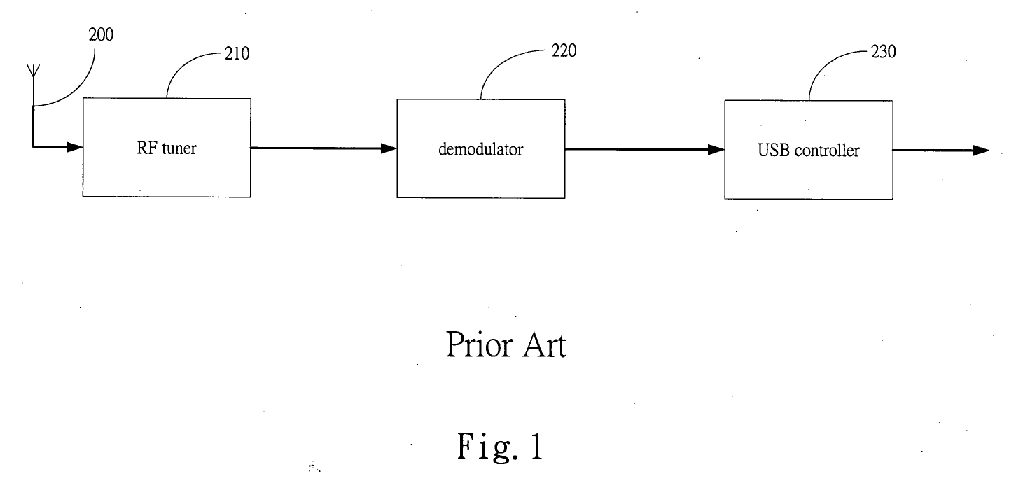

FIG. 2 shows a schematic view of a conventional DVB transmission packet;

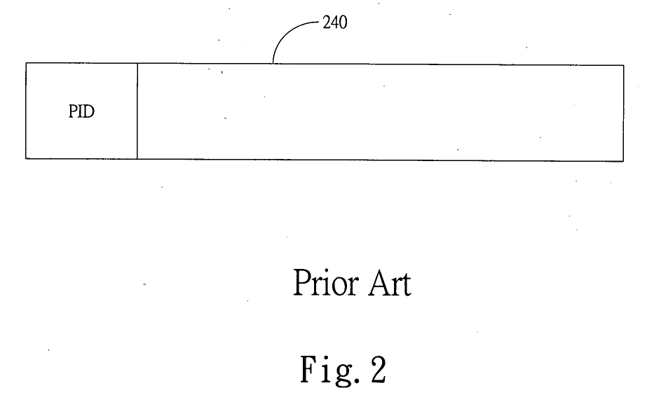

FIG. 3 shows a block diagram of a controller for filtering DVB sub-channels in accordance with a first embodiment of the present invention;

FIG. 4 shows a flowchart of a data compression unit of FIG. 3 to perform data compression on DVB packets;

FIG. 5 shows a schematic view of a compressed packet from the data compression unit; and

FIG. 6 shows a block diagram of a controller for filtering DVB sub-channels in accordance with a second embodiment of the present invention.

### DETAILED DESCRIPTION OF THE PREFERRED EMBODIMENTS

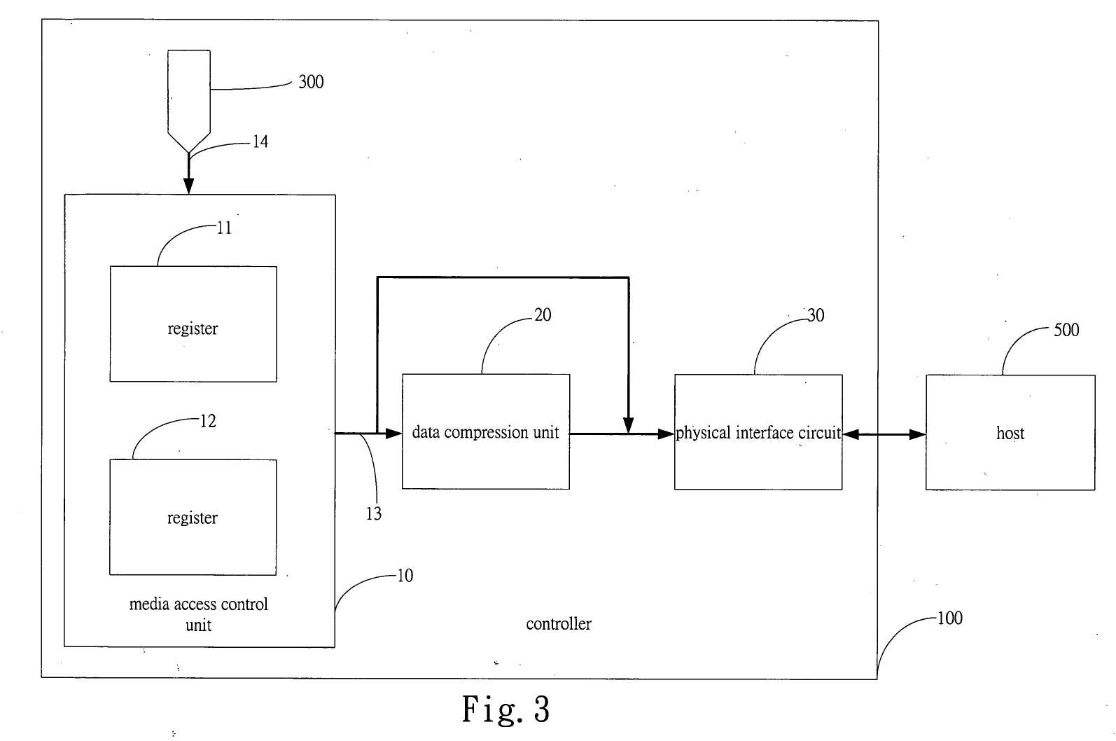

With reference to the drawings and in particular to FIG. 3, which shows a controller for filtering DVB sub-channels in accordance with a first embodiment of the present invention and generally designated with the reference numeral 100, the controller 100 comprises a media access control (MAC) unit 10, at least a data compression unit 20 and at least a physical interface circuit 30. The MAC unit 10 comprises a plurality of registers 11, 12 and an output end 13. The number of registers 11, 12 is not limited to any specific number, and the present embodiment uses two registers 11, 12 for illustration. The MAC unit 10 is externally connected to a bus 14, and is further connected to input a DVB packet 300 through the bus 14.

Table 1, provided in the following, shows the DVB channels in Taiwan, including CTV, PTS, FTV, TTV and CTS. Each TV station has a fixed broadcast channel, and can broadcast a plurality of sub-channels, called SDTV. For example, TTV is the broadcast channel with a central frequency at 581 MHz, and can transmit thee sub-channels for selection. Each sub-channel includes a different video program identification (PID) P1 and an audio PID P2. Each sub-channel has a bandwidth of 6 MHz. In addition, the control packets for PID P1, PID P2 are also transmitted within the bandwidth of each TV station.

TABLE 1

| TV Station | Central Frequency | Video PID P1 | Audio PID P2 |
|---|---|---|---|
| CTV 1 | 53300 | 33 | 36 |
| CTV 2 | 53300 | 49 | 52 |
| PTS 1 | 54500 | 2011 | 2012 |
| PTS 2 | 54500 | 2021 | 2022 |
| PTS 3 | 54500 | 0 | 2032 |
| FTV 1 | 55700 | 3001 | 3002 |
| FTV 2 | 55700 | 3011 | 3012 |
| FTV 3 | 55700 | 3021 | 3022 |
| TTV 1 | 58100 | 4001 | 4002 |
| TTV 2 | 58100 | 4011 | 4012 |
| TTV 3 | 58100 | 4021 | 4022 |
| CTS 1 | 59300 | 5011 | 5012 |
| CTS 2 | 59300 | 5021 | 5022 |
| CTS 3 | 59300 | 5031 | 5032 |

The MAC unit 10 performs a table lookup based on the SDTV corresponding to the DVB packet 300 to obtain all the video PID P1 and audio PID P2 belonging to the SDTV of the same central frequency. For example, when TTV 1 is selected, the central frequency of TTV is 581 MHz. The MAC unit 10 finds the correct video PID is 4001 and audio PID is 4002. By table lookup, the remaining video PIDs having the same central frequency are 4011, 4021, which will be stored in the registers 11, 12, respectively. The MAC unit 10 can then used the stored video PIDs to determine whether DVB packet 300 should be discarded, compressed and output, or output directly. This will save the transmission bandwidth.

The MAC unit 10 can be a microprocessor, with a pre-loaded control program, for determining to discard, compress and output or directly output the DVB packet 300 based on the stored video PIDs P1 in the registers 11, 12. For example, DVB packets 300 having the same PID as the PID P1 in the registers 11, 12 can be discarded, or on the other hand compressed and output, or output directly.

The data compression unit 20 is connected to the output end 13 of the MAC unit 10 for being controlled by the MAC unit 10 to activate data compression and receive the DVB packet 300 for compression from the output end 13. The data compression unit 20 is not limited to any specific type, and the present embodiment uses a Huffman lossless compression module and a lossless compression method for description. Other equivalent compression modules and methods are also within the scope of the present invention. The Huffman lossless method is targeting at the MPEG2 format of DVB packet 300 for lossless compression so that the compressed DVB packet 300 can be uncompressed to the original MPEG2 format video data.

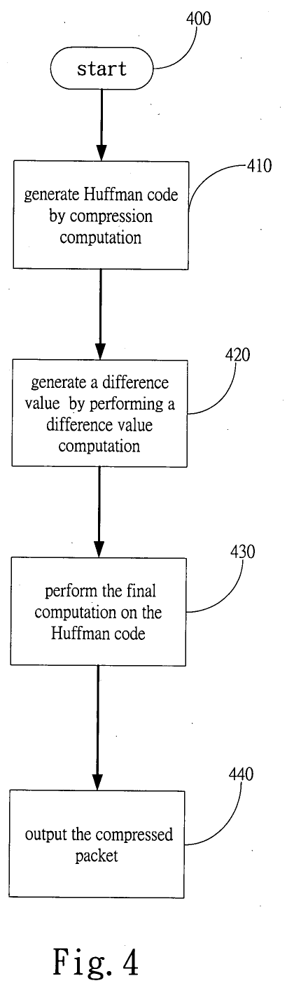

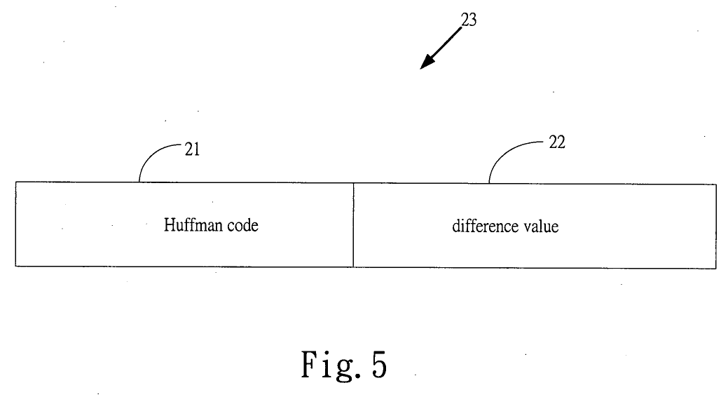

FIG. 4 shows a flowchart of the data compression unit 20 of FIG. 3 to perform Huffman lossless data compression on DVB packets 300, including steps of 400-440. Starting with step 400, step 410 is to generate Huffman code by compression computation. The compression computation is performed on the DVB packets 300 from the MAC unit 10 to generate a Huffman code 21, as shown in FIG. 5. Step 420 is to generate a difference value 22 by performing a difference value computation on the RGB and grayscale data in the DVB packets 300 from the MAC unit 10, as shown in FIG. 5. Step 430 is to perform the final computation on the Huffman code 21 from step 410 and the difference value 22 from step 420 by making the Huffman code 21 as the higher bits and the difference value 22 as lower bits to form a compressed packet 23. Step 440 is to output the compressed packet 23 from step 430, as shown in FIG. 5, through the data compression unit 20.

The physical interface circuit 30 is not limited to any specific type. The present embodiment uses a physical interface circuit of USB1.1 specification for description. The physical interface circuit 30 is connected to the output end 13 of the MAC unit 10 and the data compression unit 20 for directly outputting DVB packets 300 from the MAC unit 10 or converting the compressed packet 23 from the data compression unit 20 into a USB format and outputting the converted signal. The physical interface circuit 30 is externally connected to a host 500, as shown in FIG. 3, or other HDTV device (not shown in the figure) for playing DVB programs. The host 500 can also play DVB packets 300 through a DVB application program or uncompress the compressed packet 23 before playing. The DVB application program on the host 500 is known and is not within the scope of the present invention.

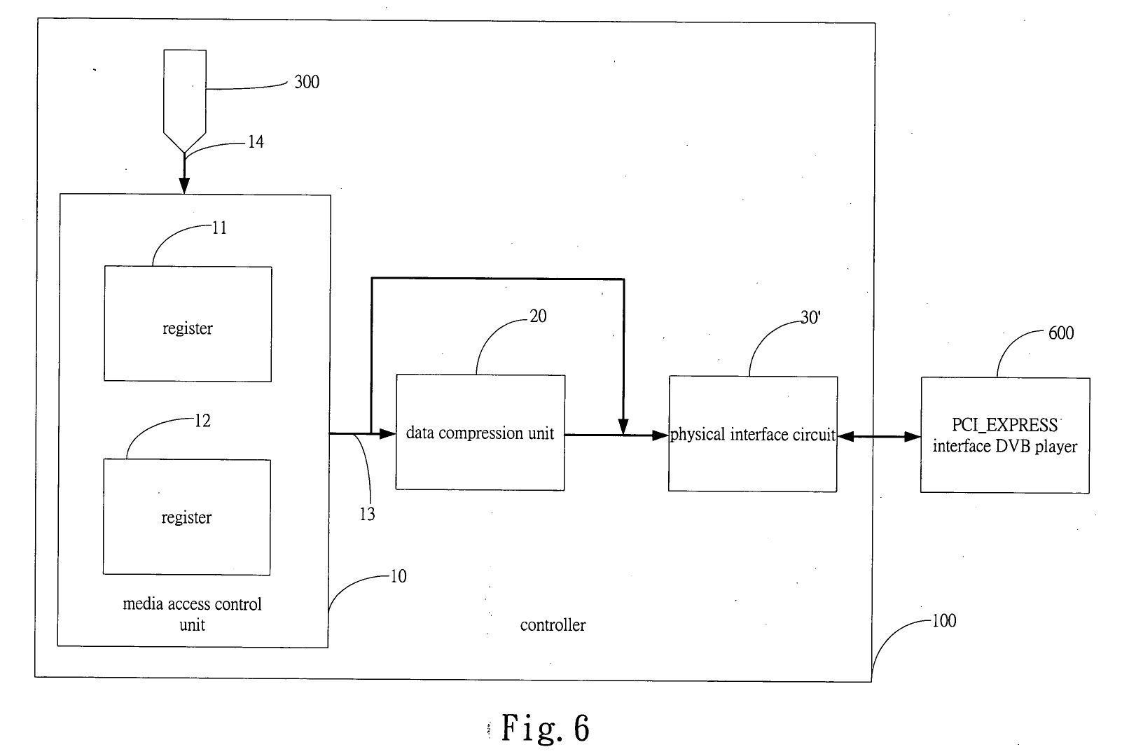

FIG. 6 shows a second embodiment of the present invention. As shown in FIG. 6, a physical interface circuit 30′ is a PCI₁₃ EXPRESS physical interface control circuit. The physical interface circuit 30′ is externally connected to a PCI_EXPRESS interface DVB player 600 for directly outputting DVB packets 300 from the output end 13 of the MAC unit 10 or converting compressed packets 23 from the data compression unit 20 into PCI_EXPRESS interface data format for the PCI _EXPRESS interface DVB player 600 to play.

The present invention targets at the sub-channel of DVB, with each having a video PID, an audio PID and a plurality of control packets, and having a bandwidth of 6 MHz. As the embodiment in FIGS. 3-6, USB interface transmission can be full speed or high speed, with each transmission bandwidth of 12 Mbps and 480 Mbps, respectively. For USB2.0 high speed transmission, the 480 Mbps bandwidth is sufficient for DVB. But for USB1.1 full speed transmission, the bandwidth is only 12 Mbps, and the total bandwidth of all the sub-channels with the same central frequency exceeds the USB1.1 full speed transmission bandwidth. For example, the TTV includes three sub-channels TTV1, TTV2, TTV3, and the total bandwidth is 18 MHz, which exceeds the 12 Mbps available in USB1.1. Thus, the bandwidth problem arises.

The controller of the present invention can use only the simplest hardware to implement the design. For example, the current sub-channel allocation for TV station in Taiwan is three-sub-channels for a central frequency. When there are N sub-channels (N=3 in Taiwan), only N−1 (N−1=2) registers are required in the MAC unit 10 to store the PIDs P1 for filtering unwanted packets. Therefore, even when the user selects a sub-channel and allows all the DVB packets 300 reaching the host 500 or the PCI_EXPRESS interface DVB player 600, the actual data traffic between the controller 100 and the host 500 or the PCI_EXPRESS interface DVB player 600 is less than 6 Mbps, or even less when compression is applied. With the addition of DVB packets of other sub-channels, the 12 Mbps bandwidth of USB1.1 is sufficient to receive a sub-channel of DVB and transmit DVB packets 300 to the host 500 or the PCI_EXPRESS interface DVB player 600 for playing.

While the invention has been described in connection with what is presently considered to the most practical and preferred embodiments, it is to be understood that the invention is not to be limited to the disclosed embodiment, but on the contrary, is intended to cover various modifications and equivalent arrangement included within the spirit and scope of the appended claims.

What is claimed is:

1. A controller for filtering sub-channels of digital video broadcast (DVB), comprising:
a media access control (MAC) unit, connected externally to a bus for inputting DVB packets, the MAC unit comprising a plurality of registers and an output end, the registers for storing video program identification (PID) in the DVB packets corresponding to sub-channels for the MAC unit to determine whether to discard, compress and output, or output directly the DVB packets through the output end,
at least a data compression unit, connected to the output end of the MAC unit, for being controlled by the MAC unit to activate data compression to compress and output the DVB packets from the MAC unit; and
at least a physical interface circuit, connected to the MAC unit and the data compression unit for outputting the DVB packets from the MAC unit directly or converting the compressed packets from the data compression unit into an interface format signal and outputting the converted signal.

2. The controller as claimed in claim 1, wherein the MAC unit comprises a microprocessor.

3. The controller as claimed in claim 1, wherein the data compression module comprises a lossless compression module.

4. The controller as claimed in claim 1, wherein the data compression module comprises a Huffman compression module.

5. The controller as claimed in claim 1, wherein the physical interface circuit comprises a USB physical interface circuit.

6. The controller as claimed in claim 5, wherein the USB physical interface circuit is of USB1.1 specification.

7. The controller as claimed in claim 1, wherein the physical interface circuit comprises a PCI_EXPRESS physical interface control circuit.

8. The controller as claimed in claim 1, wherein the physical interface circuit is connected to a computer host.

9. The controller as claimed in claim 1, wherein the physical interface circuit is connected to a PCI_EXPRESS interface DVB player.
